(19) United States
(12) Patent Application Publication
(10) Pub. No.: US 2026/0042293 A1
(43) Pub. Date: Feb. 12, 2026

(54) ELEMENT SUBSTRATE AND LIQUID EJECTION HEAD

(71) Applicant: CANON KABUSHIKI KAISHA, Tokyo (JP)

(72) Inventors: MAKI KATO, Tokyo (JP); TAKERU YASUDA, Kanagawa (JP); YOHEI OSUKI, Chiba (JP); AKIHISA IIO, Kanagawa (JP); REI KURASHIMA, Kanagawa (JP)

(21) Appl. No.: 19/292,154

(22) Filed: Aug. 6, 2025

(30) Foreign Application Priority Data
Aug. 7, 2024 (JP) 2024-130777
Jun. 4, 2025 (JP) 2025-093543

(51) Int. Cl. B41J 2/14

(52) U.S. Cl. CPC B41J 2/14233; B41J 2002/14241; B41J 2002/14491

(57) ABSTRACT

An element substrate capable of applying an equal voltage to piezoelectric elements while maintaining high reliability. The element substrate includes a pressure chamber, a diaphragm, and a piezoelectric device. The piezoelectric device includes a first electrode, a piezoelectric layer, a second electrode, an insulation layer, a first wiring, a second wiring, and a deformation suppression portion. The piezoelectric device has a first region in which the first electrode, the insulation layer, and the first wiring are laminated, a second region in which the first electrode, the piezoelectric layer, the insulation layer, and the deformation suppression portion are laminated, and a third region in which the first electrode, the piezoelectric layer, the insulation layer, and the second wiring are laminated. The deformation suppression portion is electrically isolated from the piezoelectric layer.

### BACKGROUND

### Field of the Technology

The present disclosure relates to an element substrate and a liquid ejection head.

### Description of the Related Art

Some liquid ejection heads to eject liquids such as inks use an element substrate. The liquid ejection heads include piezoelectric elements each configured to displace a diaphragm, thereby ejecting a liquid from an ejection port.

Japanese Patent Laid-Open No. 2019-025796 discloses a configuration in which a first wiring and a second wiring are connected to a second electrode, arranged on an upper surface of a piezoelectric layer, from both sides in a longitudinal direction. In this configuration, both end portions of a piezoelectric element have the same film configuration, ensuring equal mechanical rigidity on both sides. This makes it possible to reduce the occurrence of a crack and thereby improve the reliability of the element substrate.

In the case of Japanese Patent Laid-Open No. 2019-025796, a third wiring connected to a first electrode arranged on a lower surface of the piezoelectric element is connected to the first electrode at a position away from the piezoelectric element in order to avoid a short circuit between the third wiring and the first and second wirings. In this case, a portion of the first electrode located within a range from the connection point to the piezoelectric element functions as a wiring.

On the other hand, in order to ensure the amount of deformation of the piezoelectric element, it is desirable for the first electrode to be formed as thin as possible. However, the thinner the film thickness of the first electrode, the higher the resistance in the first electrode. Therefore, an error in film thickness leads to a variation in the amount of voltage drop in the first electrode, and thus to a variation in the applied voltage among the piezoelectric elements. In the case where the first electrode functioning as the wiring for a long distance as in Japanese Patent Laid-Open No. 2019-025796 is used, the above variations have greater influence. The variation in the applied voltage among the piezoelectric elements leads to a variation in the amount of deformation of the diaphragm, which in turn leads to a variation in the amount of ejection and eventually appears as uneven density of an image in a case where a liquid ejection apparatus is a printing apparatus.

### SUMMARY

The present disclosure is directed to an element substrate capable of applying an equal voltage to piezoelectric elements while maintaining high reliability.

An element substrate includes: a pressure chamber configured to store a liquid; a diaphragm configured as a wall surface of the pressure chamber; and a piezoelectric device configured to vibrate the diaphragm. The piezoelectric device includes a first electrode, a piezoelectric layer laminated on the first electrode in a predetermined direction, a second electrode stacked on the piezoelectric layer in the predetermined direction, an insulation layer laminated on the second electrode in the predetermined direction, a first wiring electrically connected to the first electrode, a second wiring electrically connected to the second electrode, and a deformation suppression portion configured to partially hold down the piezoelectric layer from the predetermined direction. In a case where longitudinal directions of the piezoelectric layer are defined as directions along an X axis crossing the predetermined direction, one of the directions along the X axis is denoted by a −X direction, and the other direction along the X axis, which is opposite to the −X direction, is denoted by a +X direction, the piezoelectric device has a first region in which the first electrode, the insulation layer, and the first wiring are laminated in the predetermined direction in this order, a second region that is located at the +X direction side of the first region, and in the second region, the first electrode, the piezoelectric layer, the insulation layer, and the deformation suppression portion are laminated in the predetermined direction in this order, and a third region that is located at the +X direction side of the second region, and in the third region, the first electrode, the piezoelectric layer, the insulation layer, and the second wiring are laminated in the predetermined direction in this order. The deformation suppression portion is electrically isolated from the piezoelectric layer.

Features of the present disclosure will become apparent from the following description of embodiments with reference to the attached drawings. The following description of embodiments is described by way of example.

### BRIEF DESCRIPTION OF THE DRAWINGS

FIG. 1A is a schematic perspective view of a liquid ejection apparatus in an embodiment;

FIG. 1B is a block diagram for explaining a control configuration of the liquid ejection apparatus in an embodiment;

FIG. 2 is a schematic perspective view of a liquid ejection head in an embodiment;

FIG. 3 is a view schematically illustrating a configuration of an element substrate in an embodiment;

FIG. 4 is a cross-sectional view taken along a line IV-IV in FIG. 3;

FIG. 5A is a plan view of a piezoelectric device and its surroundings;

FIG. 5B is a cross-sectional view taken along a line Vb-Vb in FIG. 5A;

FIG. 6 is a plan view of a piezoelectric device and its surroundings in a modification;

FIG. 7A is a plan view of a piezoelectric device and its surroundings in a modification;

FIG. 7B is a cross-sectional view taken along a line VIIb-VIIb in FIG. 7A;

FIG. 8 is a plan view of a piezoelectric device and its surroundings in a modification;

FIG. 9 is a plan view of a piezoelectric device and its surroundings in a modification;

FIG. 10 is a plan view of a piezoelectric device and its surroundings in a modification;

FIG. 11 is a schematic plan view of an element substrate in an embodiment;

FIG. 12 is a cross-sectional view taken along a line XII-XII in FIG. 11;

FIG. 13 is a schematic plan view of a piezoelectric element portion in an embodiment;

FIG. 14 is a cross-sectional view taken along a line XIV-XIV in FIG. 13;

FIG. 15 is a diagram presenting a simulation result in an embodiment;

FIG. 16 is a schematic plan view of a piezoelectric element portion in a modification;

FIG. 17 is a schematic plan view of a piezoelectric element portion in a modification;

FIG. 18 is a schematic plan view of a piezoelectric element portion in a modification;

FIG. 19 is a cross-sectional view taken along a line XIX-XIX in FIG. 18;

FIG. 20 is a schematic plan view of a piezoelectric element portion in a modification;

FIG. 21 is a cross-sectional view taken along a line XXI-XXI in FIG. 20; and

FIG. 22 is a cross-sectional view taken along a line XXII-XXII in FIG. 20.

### DESCRIPTION OF THE EMBODIMENTS

### First Embodiment

### <Liquid Ejection Apparatus 100>

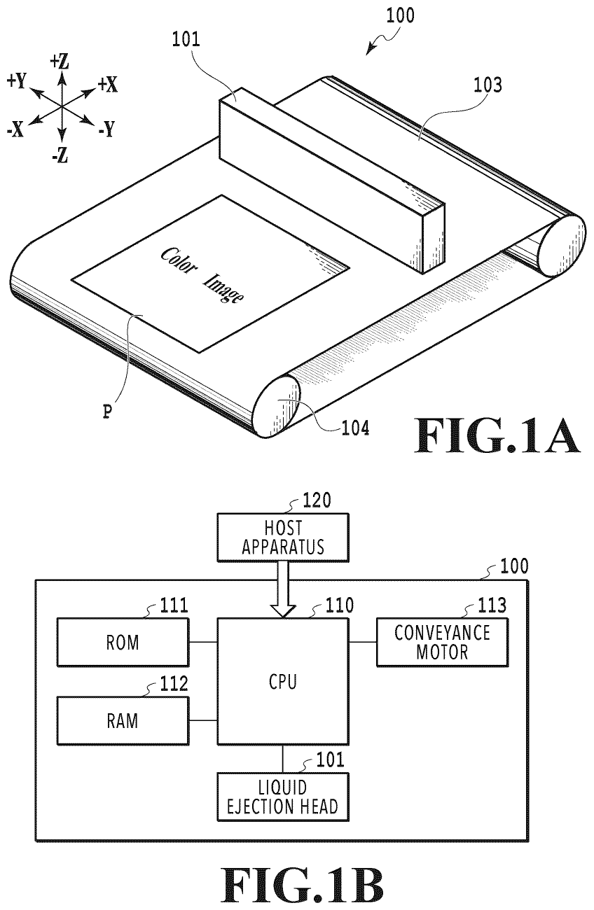

FIG. 1A is a schematic perspective view of a liquid ejection apparatus 100 to which the present embodiment is applicable.

Here, coordinate axes in the drawings will be explained. In the drawings, an X axis and a Y axis are orthogonal to each other on a plane. A Z axis is orthogonal to the X axis and the Y axis. A ±Y direction indicates a longitudinal direction of a liquid ejection head 101. A ±X direction indicates a short-side direction of the liquid ejection head 101. A −X direction is a conveyance direction of a print medium P. The −X direction will be also referred to as the conveyance direction as needed. A Z direction indicates a height direction of the liquid ejection head 101. A −Z direction is a direction in which the liquid ejection head 101 ejects liquids (for example, inks). A surface of the liquid ejection head 101 facing in the −Z direction is a bottom surface of the liquid ejection head 101.

In the present disclosure, “printing” means not only to form meaningful information (for example, such as characters and graphics which are formed noticeably so that humans can perceive them visually), but also to form meaningless information. In addition, in the present disclosure, “printing” broadly means to form an image, a design, a pattern, a structure, a combination of these, or the like on a print medium P or to process a medium.

“Print medium” include not only usual paper sheets for use in general printing apparatuses, but also any media capable of receiving liquid (for example, ink) such as cloth, plastic film, metallic plate, glass, ceramic, resin, wood, and leather.

A print medium P may be any medium on which an image can be formed with liquid droplets (for example, ink droplets) landed thereon. For example, print medium made of various materials in various forms, such as paper, cloth, optical disk label surface, plastic sheet, OHP sheet, and envelop, may be used. The present embodiment will be described on the assumption that a cut sheet is used as a print medium P.

The present disclosure will be described on the assumption that an ink is used as a liquid. However, the liquid usable in the technique of the present disclosure is not limited to the ink. As the liquid, various printing solutions other than the ink may be used, such as treatment solutions to be used for the purposes of improving ink fixing properties, reducing glossy unevenness, and improving rubfastness of the ink on a print medium P.

As illustrated in FIG. 1A, the liquid ejection apparatus 100 in the present embodiment is a full-line inkjet printing apparatus using the liquid ejection head 101 having a print region corresponding to a width of the print medium P. The print medium P is placed on a belt-shaped conveyance unit 103 and conveyed in the conveyance direction (−X direction) at a predetermined speed with rotations of a conveyance roller 104.

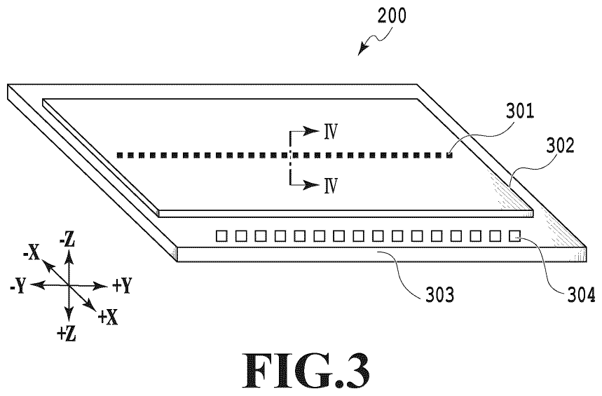

In the middle of a conveyance path, the liquid ejection head 101 is provided which includes multiple ejection ports 301 (see FIG. 3 and others) capable of ejecting a liquid. The liquid ejection head 101 ejects the liquid according to ejection data from each of the ejection ports 301 at a frequency suited to the conveyance speed of the print medium P, thereby forming a desired image on a surface of the print medium P.

FIG. 1B is a block diagram for explaining a control configuration of the liquid ejection apparatus 100 applicable to the present embodiment.

As illustrated in FIG. 1B, a CPU 110 controls the overall liquid ejection apparatus 100 according to a program stored in a ROM 111 while using a RAM 112 as a work area.

For example, according to a program and parameters stored in the ROM 111, the CPU 110 performs predetermined image processing on image data received from an external host apparatus 120 connected to the liquid ejection apparatus 100, thereby generating ejection data supported by the liquid ejection head 101. Then, according to the ejection data, the CPU 110 drives the liquid ejection head 101 and causes the liquid ejection head 101 to eject the liquid from the individual ejection ports 301 at the predetermined frequency. Moreover, while causing the liquid ejection head 101 to perform the ejection operations, the CPU 110 drives a conveyance motor 113 to rotate the conveyance roller 104, thereby conveying the print medium P in the conveyance direction at a speed suited to the ejection frequency.

Here, the liquid ejection head 101 in the present embodiment is capable of performing monochrome printing on a print medium P by ejecting a black ink. Instead, four liquid ejection heads to individually eject, for example, yellow, magenta, cyan, and black inks may be provided to perform full-color printing.

### <Liquid Ejection Head 101>

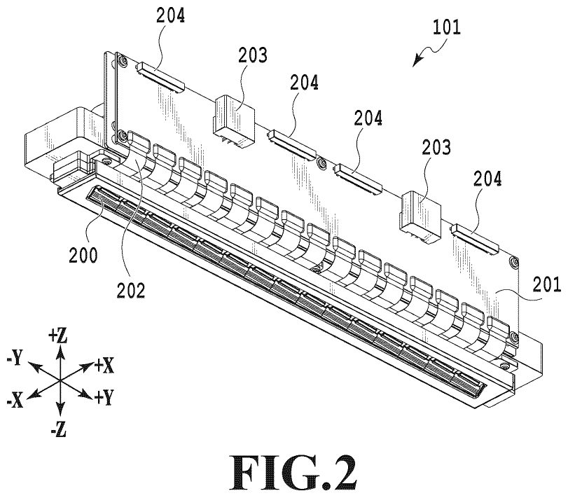

FIG. 2 is a schematic perspective view of the liquid ejection head 101 applicable to the present embodiment

As illustrated in FIG. 2, in the liquid ejection head 101, chip-shaped element substrates 200 to function as liquid ejector modules are arrayed along the Y direction, the number of the element substrates 200 being just enough to cover the width of A4 size. The liquid ejection head 101 is provided with an electric wiring board 201 and multiple flexible printed wiring boards 202 for connecting the element substrates 200 to the electric wiring board 201, in addition to the multiple element substrates 200. The electric wiring board 201 is provided with power supply terminals 203 for receiving electric power from a main body of the liquid ejection apparatus 100 and signal input terminals 204 for receiving ejection data.

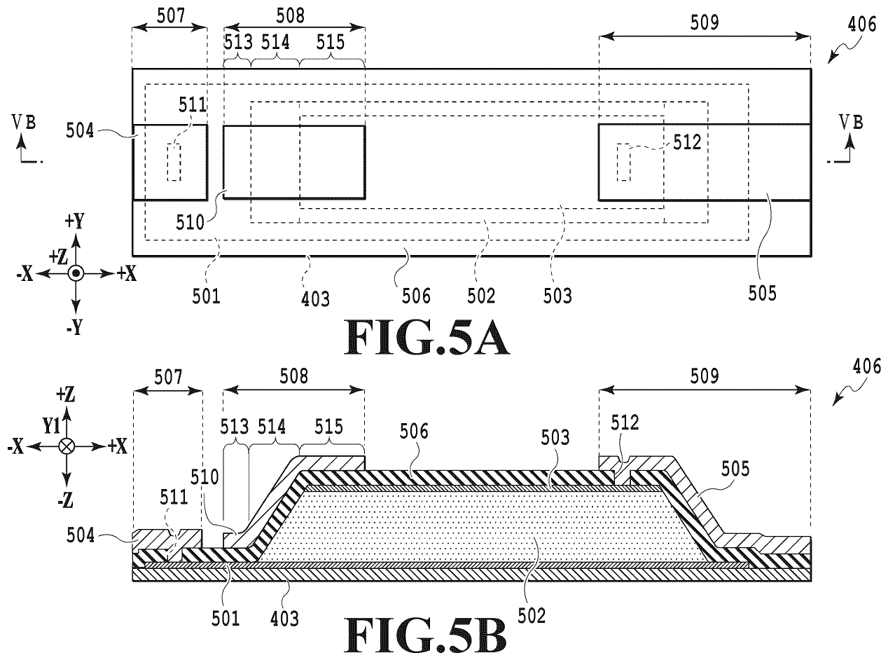

Here, the liquid ejection head 101 in the present embodiment is provided with a piezoelectric layer 502 (see FIG. 5A and others) as an energy element to generate energy for liquid ejection. In other words, the liquid ejection head 101 in the present embodiment ejects the liquid in a so-called piezoelectric method.

### <Element Substrate 200>

FIG. 3 is a schematic view illustrating a configuration of an element substrate 200 applicable to the present embodiment. FIG. 3 is an external appearance view of the element substrate 200 seen from the ejection port 301 side.

As illustrated in FIG. 3, in the element substrate 200 in the present embodiment, an ejection port forming member 302 having multiple ejection ports 301 for ejecting the liquid is laminated on an actuator board 303 to be driven with electric power supply. In FIG. 3, the multiple ejection ports 301 are formed in a single array along the Y direction. However, the number of ejection ports 301 and the number of arrays of the ejection ports 301 may be changed as needed.

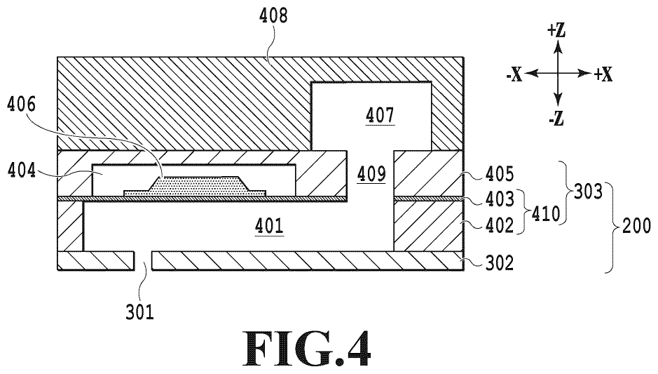

The ejection port forming member 302 in the present embodiment is constituted of a photosensitive resin or the like. Terminal portions 304 including multiple terminals for electric connection with the flexible printed wiring boards 202 (see FIG. 2) are provided on an upper surface of the actuator board 303. The shapes of the terminal portions 304 may be changed in design as appropriate according to a mounting method. FIG. 4 is a cross-sectional view taken along a line IV-IV in FIG. 3.

As illustrated in FIG. 4, the element substrate 200 in the present embodiment is fixed (for example, bonded) to a common liquid chamber board 408 including a single common liquid chamber 407 to supply the liquid to multiple supply channels 409 provided in the element substrate 200. As describe above, the element substrate 200 includes the ejection port forming member 302 and the actuator board 303. The actuator board 303 includes a first substrate 410 including a pressure chamber substrate 402 containing silicon and a flexible diaphragm 403, and a channel substrate 405 containing silicon. In the pressure chamber substrate 402, a pressure chamber 401 to temporarily store the liquid is formed. In the diaphragm 403, an opening is formed. In the channel substrate 405, a cavity 404 and the supply channels 409 are formed. In the cavity 404, a piezoelectric device 406 to be driven with electric power supply is placed. Through each supply channel 409, the liquid is supplied from the common liquid chamber 407 to the pressure chamber 401 via the opening in the diaphragm 403. The ejection port forming member 302, the pressure chamber substrate 402, the diaphragm 403, the channel substrate 405, and the common liquid chamber board 408 are laminated in this order. The diaphragm 403 is an insulation film formed of a flexible material such as a silicon oxide.

In the channel substrate 405, the piezoelectric device 406 corresponding to the pressure chamber 401 is provided. The piezoelectric device 406 is placed on the diaphragm 403 and housed inside the cavity 404. In a case where a voltage is applied to the piezoelectric device 406, the piezoelectric device 406 is deformed to bend toward the inside of the pressure chamber 401. With the deformation of the piezoelectric device 406, the diaphragm 403 is deformed integrally with the piezoelectric device 406. As a result, the volume of the pressure chamber 401 becomes smaller and the liquid in the pressure chamber 401 is more pressurized. With the liquid pressurized in the pressure chamber 401, a portion of the liquid is ejected as a liquid droplet (for example, an ink droplet) from the ejection port 301. The pressure chamber 401 is refilled with the liquid in an amount equal to the amount consumed for ejection, via the common liquid chamber 407 and the supply channel 409.

The pressure chamber 401 in the present embodiment has a shape long in a direction along the X axis and the piezoelectric device 406 provided corresponding to the pressure chamber 401 also has a rectangular shape long in the X axial direction.

FIG. 5A is a plan view of the piezoelectric device 406 and its surroundings.

As illustrated in FIG. 5A, in the plan view, the piezoelectric device 406 has a rectangular shape having a short side extending in the Y direction and a long side extending in the X direction.

FIG. 5B is a cross-sectional view taken along a line Vb-Vb in FIG. 5A.

As illustrated in FIG. 5B, the element substrate 200 (see FIG. 2 and others) includes the pressure chamber 401 (see FIG. 4), the diaphragm 403 configured as a wall surface (specifically, a ceiling surface) of the pressure chamber 401, and the piezoelectric device 406 to vibrate the diaphragm 403. In the element substrate 200, multiple pressure chambers 401, multiple diaphragms 403, and multiple piezoelectric devices 406 are provided along the Y direction.

Each of the piezoelectric devices 406 includes a first electrode 501, a piezoelectric layer 502, a second electrode 503, a first wiring 504 electrically connected to the first electrode 501, a second wiring 505 electrically connected to the second electrode 503, and an insulation layer 506 for moisture protection and insulation. Here, the longitudinal directions of the pressure chamber 401 are defined as directions along the X axis, one of the directions along the X axis is denoted by a −X direction, and the other direction along the X axis, which is opposite to the −X direction, is denoted by a +X direction. In this case, a first region 507, a second region 508, and a third region 509 are present in this order in the −X to +X direction. In other words, the second region 508 is located at the +X direction side of the first region 507, and the third region 509 is located at the +X direction side of the second region 508.

In the cross-sectional view of the piezoelectric device 406, the first electrode 501, the insulation layer 506, and the first wiring 504 are laminated in this order in the first region 507. In the second region 508, the first electrode 501, the piezoelectric layer 502, the second electrode 503, the insulation layer 506, and a deformation suppression portion 510 are laminated in this order. In the third region 509, the first electrode 501, the piezoelectric layer 502, the second electrode 503, the insulation layer 506, and the second wiring 505 are laminated in this order. Here, a distance between an end of the first wiring 504 and an end of the deformation suppression portion 510 (in other words, a space from which the conductive layer is removed) is about 5.0 μm.

The deformation suppression portion 510 in not connected to the first wiring 504, the first electrode 501, the piezoelectric layer 502, the second electrode 503, and the second wiring 505. Therefore, no electric power flows into the deformation suppression portion 510.

In the cross-sectional view of the piezoelectric device 406, the first electrode 501 is laminated on the diaphragm 403. The piezoelectric layer 502 is laminated on the first electrode 501. The second electrode 503 is laminated on the piezoelectric layer 502. The insulation layer 506 is formed so as to cover the first electrode 501, the piezoelectric layer 502, and the second electrode 503. In the insulation layer 506, a first opening 511 and a second opening 512 passing through the insulation layer 506 in the Z direction are formed in a state where the insulation layer 506 covers the first electrode 501, the piezoelectric layer 502, and the second electrode 503.

In the first region 507, the first wiring 504 is laminated on the insulation layer 506. The first wiring 504 is connected to the first electrode 501 through the first opening 511. In the second region 508, the deformation suppression portion 510 is laminated on the insulation layer 506, the deformation suppression portion 510 holding down the piezoelectric layer 502 having a predetermined height so as to mount over the piezoelectric layer 502. In the cross-sectional view of the piezoelectric device 406, the shape of the piezoelectric layer 502 is a laterally-symmetric trapezoid.

The deformation suppression portion 510 includes a first flat portion 513 holding down the first electrode 501 from above the insulation layer 506 and an inclined portion 514 holding down an inclined portion of the piezoelectric layer 502 from above the insulation layer 506. The deformation suppression portion 510 includes a second flat portion 515 holding down the second electrode 503, the upper bottom and the lower bottom of the piezoelectric layer 502, and the first electrode 501 from above the insulation layer 506. The first flat portion 513, the inclined portion 514, and the second flat portion 515 are continuously formed in this order in the −X to +X direction. In this way, the deformation suppression portion 510 is formed to mount over the piezoelectric layer 502 having the predetermined height and the second electrode 503 from the −X direction side.

The first wiring 504, the deformation suppression portion 510, and the second wiring 505 are collectively formed by selectively removing portions of a common conductive layer (single layer or multiple layers). Accordingly, the first wiring 504, the deformation suppression portion 510, and the second wiring 505 are formed of the common conductive material so as to have substantially the same film thickness.

For example, the first wiring 504, the deformation suppression portion 510, and the second wiring 505 are collectively formed in a way in which a low-resistance metal conductive layer such as gold is formed by a known film formation technique such as sputtering and then is selectively removed by a known process technique such as photolithography. The film thickness of the first wiring 504, the deformation suppression portion 510, and the second wiring 505 is thicker than the film thickness of the second electrode 503. For example, the second electrode 503 is formed with a film thickness thin enough not to excessively suppress the deformation of the piezoelectric layer 502. On the other hand, the first wiring 504 and the second wiring 505 are formed with a film thickness considerable to sufficiently reduce the electrical resistance.

With the deformation suppression portion 510 provided in this way, the rigidity of the −X direction side of the piezoelectric layer 502 can be equalized to the rigidity of the +X direction side of the piezoelectric layer 502 on which the second wiring 505 is provided.

In and around a +X direction-side end of the piezoelectric layer 502, the first electrode 501, the piezoelectric layer 502, the second electrode 503, the insulation layer 506, and the second wiring 505 are laminated in this order. In and around a −X direction-side end of the piezoelectric layer 502, the first electrode 501, the piezoelectric layer 502, the second electrode 503, the insulation layer 506, and the deformation suppression portion 510 are laminated in this order.

The deformation suppression portion 510 is formed of the same material as the second wiring 505 and provided with the same thickness as the second wiring 505, which makes it possible to reduce the occurrence of a crack due to rigidity inequality between these two ends. If the deformation suppression portion 510 were not provided, a crack may occur due to the rigidity inequality between the two X direction-side (longitudinal) ends of the piezoelectric layer 502.

The deformation suppression portion 510 does not necessarily have to be apart from the first wiring 504. However, with electrical safety taken into consideration, it is preferable to place the deformation suppression portion 510 apart from the first wiring 504. In particular, in the case where the first wiring 504 and the second wiring 505 are formed of the same material, the deformation suppression portion 510 has to be formed apart from the first wiring 504.

If the deformation suppression portion 510 were connected to the first wiring 504, voltages with an equal potential supplied from the first wiring 504 may be applied to the inclined portion 514 from the first electrode 501 and the deformation suppression portion 510 via the insulation layer 506. As a result of the application of the voltages with the equal potential, the inclined portion 514 may not be deformed and a local stress difference may occur at the boundary between the inclined portion 514 and the second flat portion 515, which may cause a crack. With the deformation suppression portion 510 formed as an isolated pattern apart from the first wiring 504, the occurrence of such a crack can be reduced.

The deformation suppression portion 510 is arranged substantially symmetrically to the second electrode 503, thereby playing a role in eliminating the rigidity inequality. On the other hand, the deformation suppression portion 510 also plays a role in acting in such a direction as to hinder the diaphragm 403 from being displaced. In order to ensure a sufficient amount of displacement relative to a drive voltage, it is necessary to strike a balance between the amount of displacement and the shape and the arrangement position of the deformation suppression portion 510.

In the present embodiment, the first wiring 504, the deformation suppression portion 510, and the second wiring 505 are made of the same material and are simultaneously formed by the photolithographic technique as described above. As a result, the deformation suppression portion 510 and the second wiring 505 both covering the piezoelectric layer 502 have the equal rigidity.

In the present embodiment, the first electrode 501 is also used as the wiring, but no electric power flows into the deformation suppression portion 510. Therefore, even if the distance between the first wiring 504 and the deformation suppression portion 510 is reduced, no electrical problems occur. According to this configuration, the contact point between the first wiring 504 and the first electrode 501 can be located closer to the piezoelectric layer 502 than in the configuration of Japanese Patent Laid-Open No. 2019-025796. Therefore, according to the configuration in the present embodiment, the section in which the first electrode 501 is used as the wiring can be made shorter than in the configuration of Japanese Patent Laid-Open No. 2019-025796. This makes it possible to more reduce variations in electrical resistance among the multiple piezoelectric devices 406 arrayed in the Y direction and thereby more equalize their amounts of ejection than in the technique in Japanese Patent Laid-Open No. 2019-025796.

In addition, the −X direction-side end of the piezoelectric layer 502 is held down by the deformation suppression portion 510 and the +X direction-side end of the piezoelectric layer 502 is held down by the second wiring 505. This can reduce the occurrence of a crack.

Thus, according to the element substrate 200 in the present embodiment, it is possible to apply an equal voltage to the piezoelectric elements while maintaining high reliability.

### First Modification of First Embodiment

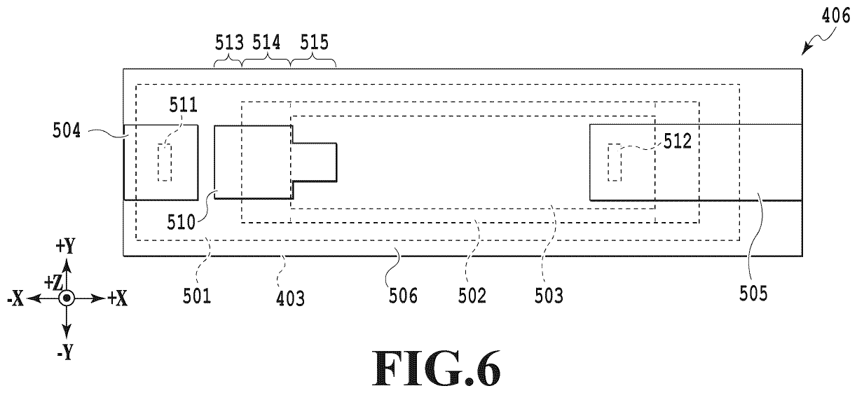

FIG. 6 is a plan view of a piezoelectric device 406 and its surroundings in the present modification.

As illustrated in FIG. 6, in the plan view of the piezoelectric device 406, a first flat portion 513 and an inclined portion 514 in a deformation suppression portion 510 are formed with an equal width (length in the Y direction). On the other hand, a second flat portion 515 is formed with a width (length in the Y direction) smaller than the width of the first flat portion 513 and the inclined portion 514.

The deformation suppression portion 510 having such a shape makes it possible to efficiently displace a piezoelectric layer 502 while maintaining of the reliability.

### Second Modification of First Embodiment

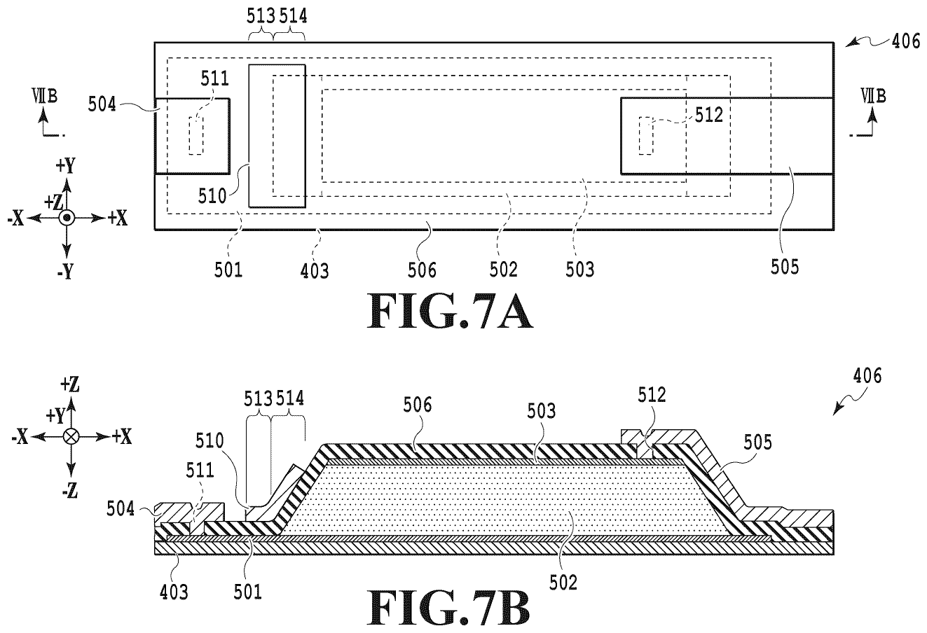

FIG. 7A is a plan view of a piezoelectric device 406 and its surroundings in the present modification.

As illustrated in FIG. 7A, in the plan view of the piezoelectric device 406, a deformation suppression portion 510 in the present modification does not include a second flat portion 515. In the present modification, a first flat portion 513 has a width (length in the Y direction) that covers an entire area in the Y direction of an −X direction-side end of a piezoelectric layer 502. The width (length in the Y direction) of an inclined portion 514 in the present modification is the same as the width of the first flat portion 513. On the other hand, the length of the inclined portion 514 (length in the X direction) is shortest among the examples described above.

FIG. 7B is a cross-sectional view taken alone a line VIIb-VIIb in FIG. 7A.

As illustrated in FIG. 7B, the deformation suppression portion 510 in the present modification holds down only a base area of the piezoelectric layer 502. The inclined portion 514 in the present modification is formed to extend only partway on an inclined portion of the piezoelectric layer 502.

In general, a crack tends to occur from the base area of the piezoelectric layer 502 to the inner side. In the present modification, the deformation suppression portion 510 is provided on only the base area of the piezoelectric layer 502 which is an area where a crack is likely to occur. This configuration does not apply an excessive load to the piezoelectric layer 502, thereby making it possible to enhance the displacement efficiency of the piezoelectric layer 502. The shape of the deformation suppression portion 510 is not limited as long as the deformation suppression portion 510 can hold down only the base area of the piezoelectric layer 502.

The configuration in which only the base area of the piezoelectric layer 502 is held down as described above makes it possible to more efficiently reduce variations in electrical resistance and maintain the reliability.

### Third Modification of First Embodiment

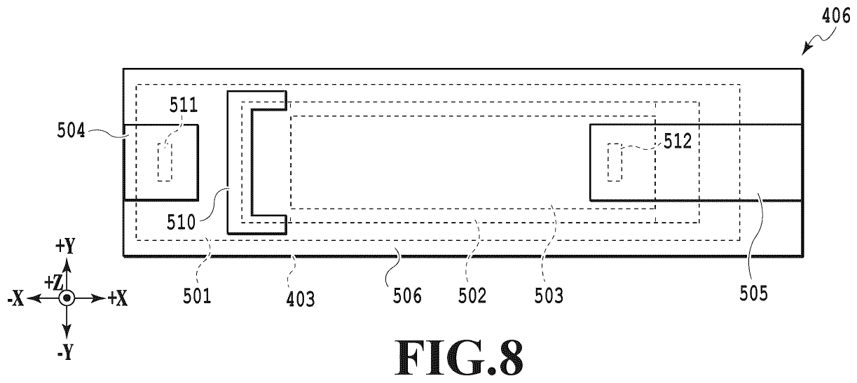

FIG. 8 is a plan view of a piezoelectric device 406 and its surroundings in the present modification.

As illustrated in FIG. 8, in the plan view of the piezoelectric device 406, a deformation suppression portion 510 may be formed in a letter-C form.

The configuration as above also makes it possible to more efficiently reduce variations in electrical resistance and maintain the reliability.

### Fourth Modification of First Embodiment

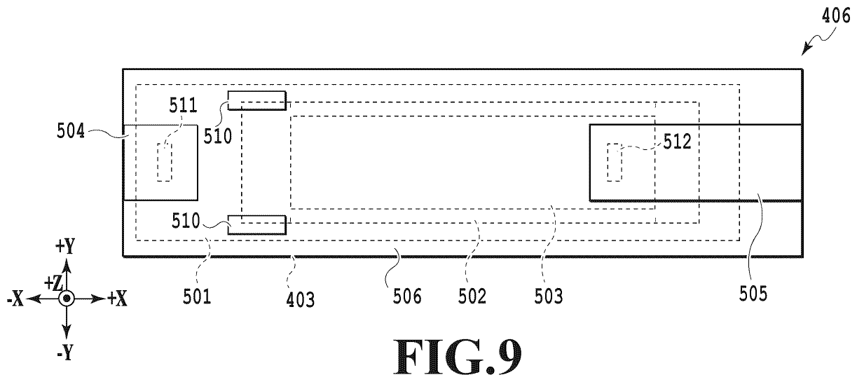

FIG. 9 is a plan view of a piezoelectric device 406 and its surroundings in the present modification.

As illustrated in FIG. 9, in the plan view of the piezoelectric device 406, a deformation suppression portion 510 is divided into two. On a −X direction-side end of a piezoelectric layer 502, two deformation suppression portions 510 hold down a +Y direction-side end and a −Y direction-side end of the piezoelectric layer 502, respectively.

The configuration as above also makes it possible to more efficiently reduce variations in electrical resistance and maintain the reliability.

### Fifth Modification of First Embodiment

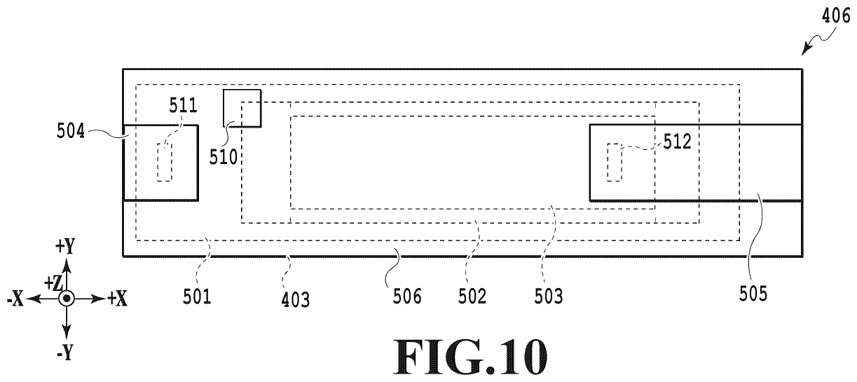

FIG. 10 is a plan view of a piezoelectric device 406 and its surroundings in the present modification.

As illustrated in FIG. 10, in the plan view of the piezoelectric device 406, on a −X direction-side end of a piezoelectric layer 502, a deformation suppression portion 510 in the present modification holds down a +Y direction-side corner of the piezoelectric layer 502. Here, the deformation suppression portion 510 holds down the +Y direction-side corner of the piezoelectric layer 502 in the example of FIG. 10, but may hold down a −Y direction-side corner.

The configuration as above also makes it possible to more efficiently reduce variations in electrical resistance and maintain the reliability.

### Second Embodiment

Hereinafter, differences from the first embodiment will be described mainly, while the same or similar constituent elements to those in the first embodiment will be given the same reference signs and explanation thereof will be omitted as appropriate.

As illustrated in FIG. 4, an element substrate 200 in the present embodiment includes an ejection port forming member 302, a first substrate 410, and a channel substrate 405. In general, in a case where the element substrate 200 is manufactured by using a common MEMS process, the ejection port forming member 302, the first substrate 410, and the channel substrate 405 contains silicon. However, the element substrate 200 may be formed of a combination of a silicon substrate and another member (for example, a mold or the like). The present embodiment has an object to maintain high reliability of the element substrate 200.

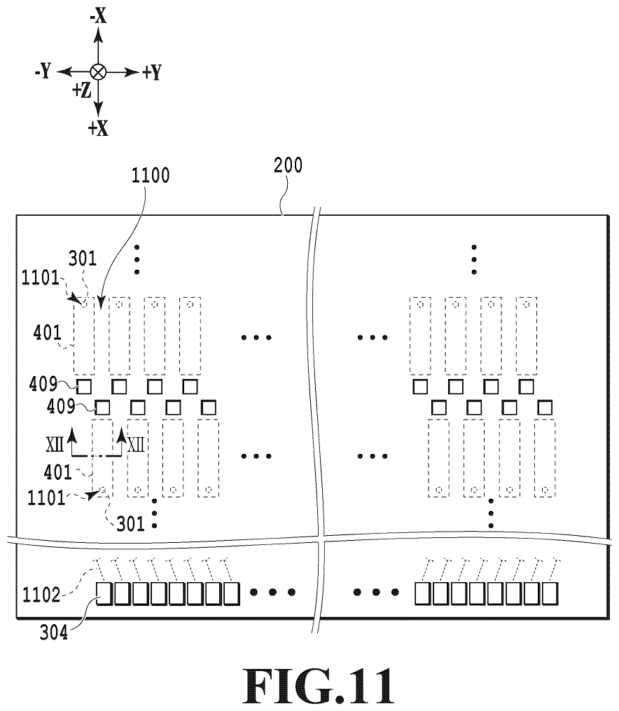

FIG. 11 is a schematic plan view of the element substrate 200 in the present modification.

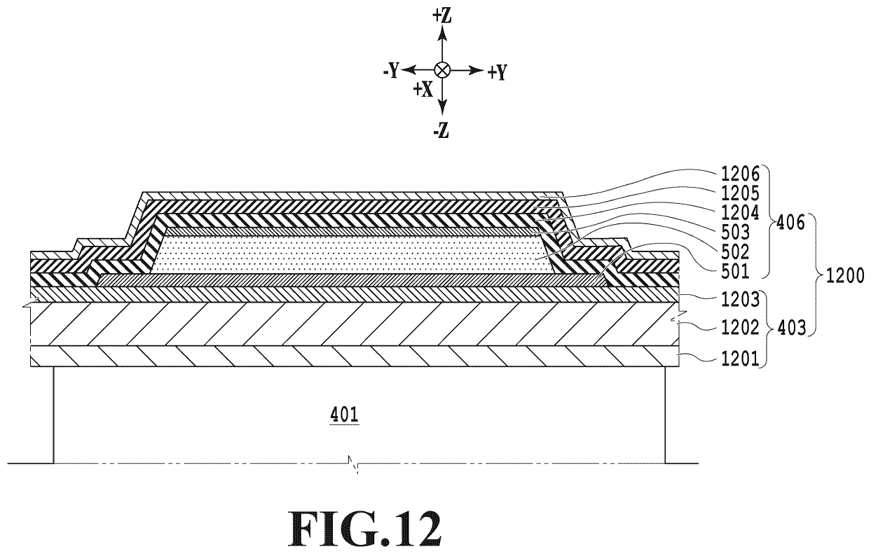

As illustrated in FIG. 11, in the element substrate 200 in the present embodiment, multiple pressure chambers 401 are arrayed along the Y direction. Two pressure chambers 401 adjacent in the Y direction are partitioned by a partition wall 1100. As a result, each of the multiple pressure chambers 401 hardly receives direct influence by piezoelectric element portions 1200 (see FIG. 12) provided at positions corresponding to the adjacent pressure chambers 401.

Each of the piezoelectric element portions 1200 (see FIG. 12) includes a diaphragm 403, a first electrode 501, a piezoelectric layer 502, a second electrode 503, a first insulation film 1204, a second insulation film 1205, and a sealing layer 1206.

The diaphragm 403 (see FIG. 12 and others) generates pressure in the liquid in the pressure chamber 401 with an action of the piezoelectric layer 502. For example, in a situation where the ink contained in the pressure chamber 401 is stable, a meniscus is formed in the ejection port 301. Upon application of a voltage to the piezoelectric element portion 1200 according to an ejection signal, the piezoelectric element portion 1200 is deformed to expand and contract the volume of the pressure chamber 401.

In the pressure chamber 401, a combination of expansion and contraction breaks the meniscus, thereby causing a liquid droplet to be ejected from the ejection port 301 to an outside (for example, a −Z direction side). In this way, in the piezoelectric element portion 1200, the piezoelectric device 406 (see FIG. 12) and the diaphragm 403 act to apply the pressure to the liquid in the pressure chamber 401. As the liquid in the pressure chamber 401 is consumed by the ejection operation, the pressure chamber 401 is resupplied with the liquid from a common liquid chamber 407 (see FIG. 4) by capillary force, and a meniscus is formed again in the ejection port 301.

A material for constituting the diaphragm 403 is selected depending on mechanical properties, durability, or the like. Examples of the material for the diaphragm 403 include a silicon nitride film, silicon, a metal, a heat-resistant glass, and so on.

Examples of a method of forming the piezoelectric layer 502 include vacuum sputtering deposition, sol-gel solution deposition, and chemical vapor deposition (CVD), and so on. The piezoelectric layer 502 may be fired after deposition. An example of a method of heating the piezoelectric layer 502 is lamp annealing heating or the like. The firing temperature of the piezoelectric layer 502 is at most 600° C. or higher and 800° C. or lower.

In order to manufacture the piezoelectric element portion 1200, the piezoelectric device 406 is directly formed on the diaphragm 403, and these are fired together. Instead, the piezoelectric device 406 may be formed and fired on another substrate and then be peeled off and transferred onto the diaphragm 403. Alternatively, the piezoelectric device 406 may be formed on another substrate, be peeled off and transferred onto the diaphragm 403, and then these are formed together to manufacture the piezoelectric element portion 1200.

The first electrode 501 is formed on one of the surfaces of the piezoelectric layer 502 (the lower surface in the example of FIG. 12), whereas the second electrode 503 is formed on the other surface of the piezoelectric layer 502 (the upper surface in the example of FIG. 12). Examples of a material for the first electrode 501 and the second electrode 503 in a case where these electrodes are to undergo a firing process include precious metals with high heat resistance (specifically, Pt, Ir, and so on). On the other hand, examples of a material for the first electrode 501 and the second electrode 503 in a case where the firing process can be separated into two or more steps include Au-based alloys, Al-based alloys, and the like.

With the controllability of the piezoelectric layer 502 taken into consideration, it is desirable that the piezoelectric layer 502 be formed by using a material having a high linearity in displacement responsive to voltage and be driven within a voltage range with a high linearity. An example of a material for the piezoelectric layer 502 satisfying these conditions is a PZT-based ceramic. In reality, the displacement characteristics of the piezoelectric layer 502 are affected by saturation characteristics, hysteresis characteristics, nonlinearity of electrostriction, and so on.

In the element substrate 200 (see FIG. 11) in the present embodiment, multiple ejection ports 301 are formed along the Y direction. The density at which these ejection ports 301 are formed (ejection port arrangement density) is not particularly limited. For example, the ejection port arrangement density may be 150 npi (nozzle per inch), 300 npi, 600 np, or higher than 600 npi.

The viscosity of an ink used as the liquid is 1 cP or more and 20 cP or less. The driving waveform of the piezoelectric element portion 1200 in the present embodiment is adjusted so that the minimum amount of the ink ejected from each of the multiple ejection ports 301 is several picoliters. For example, in the case where the ejection port arrangement density is 300 npi, the width (length in the Y direction) of the pressure chamber 401 is smaller than in the case where the ejection port arrangement density is 150 npi. For this reason, it is necessary to form the diaphragm 403 thinly enough to ensure the necessary amount of displacement.

In general, the driving frequency of each of the multiple piezoelectric elements is 10 kHz or higher and 100 kHz or lower. This driving frequency is set in consideration of a time required for the piezoelectric element portion 1200 to eject the ink after application of the voltage thereto, then be refilled with the new ink, and get ready to perform the next ejection operation. The piezoelectric layer 502 and the pressure chamber 401 are formed by using the MEMS process using silicon substrates.

In the element substrate 200 in the present embodiment, multiple ejection port arrays 1101 each including multiple ejection ports 301 formed at a specified density along the Y direction are provided along the X direction. The number of ejection port arrays 1101 is not limited. For example, the number of ejection port arrays 1101 may be two or eight. In general, the length (length in the Y direction) of the ejection port array 1101 is about 0.5 inches or more and 1.5 inches or less. In a liquid ejection head 101 (see FIG. 1A and others) in the present embodiment, multiple element substrates 200 are combined.

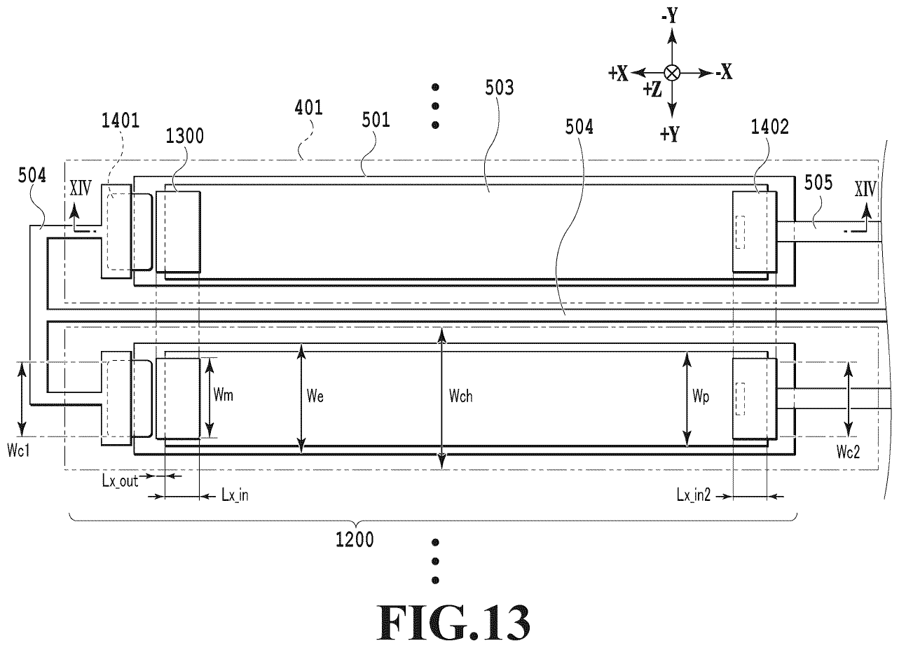

The channel substrate 405 (see FIG. 4 and others) in the present embodiment is provided with wiring portions 1102 for transmitting relevant electric signals to the first electrodes 501 and the second electrodes 503. The wiring portions 1102 includes a first wiring 504 and a second wiring 505 (see FIG. 13 and others). Terminal portions 304 may be arranged collectively on one side of the channel substrate 405 or arranged dividedly on both sides of the channel substrate 405.

In the example of FIG. 11, the terminal portions 304 are provided only at a +X direction-side end of the channel substrate 405 along the Y direction. The configuration in which the terminal portions 304 are provided only on the one-side end makes it possible to reduce the number of components to be assembled and the number of steps. For example, the cost for connecting flexible printed wiring boards 202 including ICs to the terminal portions 304 can be reduced in the case where the terminal portions 304 are provided only on one side, as compared with the case where the terminal portions 304 are provided on both sides.

However, in the case where the wiring portions 1102 are put together on one side, the density of the wiring portions 1102 is increased. In this case, a constraint is imposed on the layout of the wiring portions 1102 and it is necessary to optimize the layout of the wiring portions 1102. For example, the wiring portions 1102 may be arranged in a multi-layered structure, so that the wiring portions 1102 can be distributed among multiple layers, thereby avoiding the constraint imposed on the layout of the wiring portions 1102 in a planar space.

As the ejection ports 301 are formed at a higher density, the width (length in the Y direction) of the pressure chamber 401 becomes narrower. For this reason, it is necessary to displace the piezoelectric element portion 1200 greatly in order to eject a predetermined amount of ink. As a result, during ejection, it is necessary to deform the diaphragm 403 so that the diaphragm 403 has a large curvature. The large curvature of the diaphragm 403 may increase the stress at end portions of the piezoelectric element portion 1200 and resultantly cause peeling-off. In particular, the rigidity of the piezoelectric layer 502 is lower in the lower portion than in the upper portion. For this reason, in the case where the piezoelectric element portion 1200 is deformed, the lower portion of the piezoelectric layer 502 is likely to be displaced and susceptible to large strain. In other words, peeling-off, cracks, and so on are likely to occur around the lower ends of the piezoelectric layer 502.

To address this, in the element substrate 200 in the present embodiment, a metal layer 1300 is provided above an end portion of the piezoelectric layer 502 near a first contact portion 1401 in the first electrode 501 (see FIG. 13). Multiple piezoelectric elements in the present embodiment are provided at a density of 300 npi in the Y direction. Hereinafter, the density at which multiple ejection ports are formed is assumed to be 300 npi.

In addition, it is also assumed that the length (length in the X direction) of the piezoelectric element portion 1200 is 700 μm, and the width (length in the Y direction) of the piezoelectric element portion 1200 is 50 mμ (width).

Moreover, it is also assumed that the length (length in the X direction) of the pressure chamber 401 is 750 μm, the width (length in the Y direction) of the pressure chamber 401 is 55 μm, and the height (length in the Z direction) of the pressure chamber 401 is 100 μm. In this case, the width of the pressure chamber 401 is narrower than in the case where the ejection port arrangement density is 150 npi. Accordingly, it is necessary to form the diaphragm 403 thinly enough to ensure the necessary amount of displacement.

The diameter of the ejection port 301 herein is about 20 μm. However, the diameter of the ejection port 301 may be adjusted depending on specifications of a liquid droplet. For example, the diameter of the ejection port 301 may be changed as appropriate within a range of about 10 μm to 30 μm.

FIG. 12 is a cross-sectional view taken along a line XII-XII in FIG. 11.

As illustrated in FIG. 12, the piezoelectric element portion 1200 in a membrane form is formed at a position corresponding to the pressure chamber 401. In the piezoelectric element portion 1200, the diaphragm 403 and the piezoelectric device 406 are laminated in this order from the side close to the pressure chamber 401. In the diaphragm 403, a first oxide layer 1201, a device layer 1202, and a second oxide layer 1203 are laminated in this order from the side close to the pressure chamber 401. The first oxide layer 1201 is a BOX layer and the device layer 1202 is a Si layer.

In the piezoelectric device 406, the first electrode 501, the piezoelectric layer 502, the second electrode 503, the first insulation film 1204, the second insulation film 1205, and the sealing layer 1206 are laminated in this order from the side close to the pressure chamber 401. In a case where the piezoelectric layer 502 is manufactured by using an oxide-based ceramic, it may be preferable to first form a reduction inhibition film on the piezoelectric layer 502 and then form an insulation film. In order to form a general insulation film, a SiO-based material may be used in a CVD apparatus.

However, in this method, the oxide on which the film is to be formed may be easily reduced during the gas reaction. Once this reduction occurs, the Schottky junction interface between the piezoelectric layer 502 and the second electrode 503 collapses, which may result in a degradation of leakage characteristics of the piezoelectric layer 502 and therefore lead to a decrease in long-term reliability. An effective measure to present this is to form, as a reduction inhibition film, an oxide layer (not illustrated) made of Al₂O₃ or the like by an ALD apparatus.

After that, a SiO-based or SiN-based first insulation film 1204 is formed as an insulation film for the electrode by using CVD, Tetra Ethoxy Silane (TEOS), or the like.

Next, electric contact portions for the piezoelectric layer 502 are formed on the first insulation film 1204. In the present embodiment, the metal layer 1300 to be described layer is also formed at this timing. Specifically, on the first insulation film 1204, a first contact portion 1401, a second contact portion 1402, and the metal layer 1300 are formed in the same layer made of the same material. The material is, for example, a material containing aluminum (Al), and is preferably a material different from a material to be used in the subsequent wiring forming step.

The wiring forming step tends to use an Al-based alloy film but may use another type of alloy film. Then, the SiO-based or SiN-based second insulation film 1205 and the sealing layer 1206 are sequentially formed by using CVD, TEOS, or the like. At last, portions of the sealing layer 1206 in the connection regions of the terminal portions 304 is removed.

The piezoelectric element portion 1200 is deformed at every ejection operation. Accordingly, in the case where the upper layers above the piezoelectric layer 502 are formed with too large film thicknesses, it is difficult to deform the piezoelectric element portion 1200, and it is difficult to obtain a suitable ejection operation. In order to efficiently deform the piezoelectric element portion 1200, a neutral plane defined by material mechanics is desired to be positioned near the interface between the piezoelectric device 406 and the diaphragm 403, or more desired to be slightly shifted to the diaphragm 403 side.

In a case where the first insulation film 1204 is additionally formed as an upper layer above the piezoelectric layer 502, the neutral plane is shifted toward the inner side of the piezoelectric layer 502. For this reason, the additional formation of the first insulation film 1204 as the upper layer above the piezoelectric layer 502 makes it difficult to deform the piezoelectric element portion 1200. In addition, also in a case where the sealing layer 1206 is formed on a surface layer side of the piezoelectric layer 502, a deformation of the piezoelectric element portion 1200 is suppressed.

It is desirable to form films with necessary film thicknesses at portions where the insulating and sealing functions are required. For example, it is desirable to form a film having a thickness sufficient to fulfill the insulating and sealing functions at each electric contact portion or the like. On the other hand, it is desirable to partially remove or thin an upper layer above the piezoelectric layer 502 so as to leave a minimum film thickness required as the sealing portion. With this configuration, it is possible to improve the displacement efficiency of a bending deformation of the piezoelectric element portion 1200.

Here, an inorganic film above the piezoelectric layer 502 is thinned or removed by a removal step including masking using a photoresist by a photolithography process and semiconductor plasma etching.

FIG. 13 is a schematic plan view of the piezoelectric element portion 1200 in the present embodiment.

As illustrated in FIG. 13, the length of the first electrode 501 in the X direction is shorter than the length of the pressure chamber 401 in the X direction, and the length of the first electrode 501 in the Y direction is shorter than the length of the pressure chamber 401 in the Y direction. The metal layer 1300 is formed above an end of the second electrode 503 in the X direction (on the left side in FIG. 13). The metal layer 1300 is made of an inorganic material. For example, the metal layer 1300 is a film containing Al.

Provided that the Young's modulus of the metal layer 1300 is denoted by Young's modulus E and the Young's modulus of the piezoelectric layer 502 is denoted by Young's modulus Ep, the value of the film thickness of the metal layer 1300×Young's modulus E is 10% or more and 80% or less of the value of the film thickness of the piezoelectric layer 502×Young's modulus Ep. The residual stress of the metal layer 1300 is desirably within a range of −100 MPa to +100 MPa (weak compression to weak tension). This is because the metal layer may be peeled off in the case where the residual compression stress or the residual tension stress is too strong. The above numeric values were obtained as a result of an examination on peeling prevention with process tolerance, as conditions where peeling-off may be prevented.

A length (Lx_out) of the metal layer 1300 protruding outward from the end of the second electrode 503 in the X direction is preferably 5 μm or more.

Meanwhile, a length (Lx_in) of the metal layer 1300 inwardly protruding from the end of the second electrode 503 is desirably 80% or more and 120% or less of a length (Lx_in2) of the second contact portion 1402 inwardly protruding from the other end of the second electrode 503. In short, it is desirable to satisfy the following (Formula 1).

(Lx_in2)×0.8≤(Lx_in)≤(Lx_in2)×1.2 (Formula 1)

A width (Wc1) of the first contact portion 1401 is desirably 70% or more and 100% or less of a width (We) of the first electrode 501. In short, it is desirable to satisfy the following (Formula 2).

(We)×0.7≤(Wc1)≤(We) (Formula 2)

A width (Wc2) of the second contact portion 1402 is desirably 70% or more and 100% or less of a width (Wp) of the piezoelectric layer 502 (see FIG. 12 and others) in the Y direction. In short, it is desirable to satisfy the following (Formula 3).

(Wp)×0.7≤(Wc2)≤Wp (Formula 3)

A width (Wm) of the metal layer 1300 is desirably 80% or more of the width (Wc2) of the second contact portion 1402 and equal to or less than the width (Wch) of the pressure chamber 401. In short, it is desirable to satisfy the following (Formula 4).

(Wc2)×0.8≤(Wm)≤(Wch) (Formula 4)

As a result of carrying out the examination on the peeling prevention while maintaining a displacement that satisfies the specifications of an ejected droplet with the process tolerance taken into consideration, peeling-off was prevented in the case where the conditions defined above by (Formula 1) to (Formula 4) were satisfied.

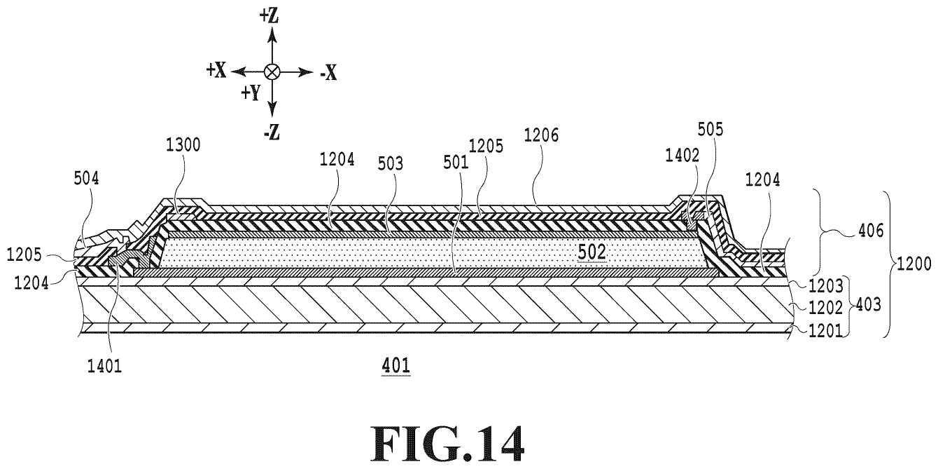

FIG. 14 is a cross-sectional view taken along a line XIV-XIV in FIG. 13.

As illustrated in FIG. 14, the piezoelectric device 406 in the membrane form is formed at a position corresponding to the pressure chamber 401 on the surface of the diaphragm 403 opposite to the ceiling surface of the pressure chamber 401. In the piezoelectric device 406, the first electrode 501, the piezoelectric layer 502, the second electrode 503, the first insulation film 1204, a conductive layer, the second insulation film 1205, the first wiring 504, and the sealing layer 1206 are laminated in this order from the pressure chamber 401 side. This conductive layer includes the first contact portion 1401, the second contact portion 1402, and the metal layer 1300. In this conductive layer, the first contact portion 1401 is isolated from the second contact portion 1402 and the second contact portion 1402 is isolated from the metal layer 1300.

The first insulation film 1204 isolates the first contact portion 1401 and the first electrode 501 from each other in a region other than a connection region where the first contact portion 1401 and the first electrode 501 are connected. The second insulation film 1205 isolates the first contact portion 1401 and the first wiring 504 from each other in a region other than a connection region where the first contact portion 1401 and the first wiring 504 are connected.

The first contact portion 1401 electrically connects the first electrode 501 and the first wiring 504, while the second contact portion 1402 electrically connects the second electrode 503 and the second wiring 505. In the first contact portion 1401, electric power flows from the first wiring 504 to the first electrode 501. In the second contact portion 1402, electric power flows from the second wiring 505 to the second electrode 503. Thus, in a case where a voltage is applied between the first wiring 504 and the second wiring 505 via the piezoelectric layer 502, the diaphragm 403 is deformed to cause the liquid in the pressure chamber 401 to be ejected from the ejection port 301.

The first insulation film 1204 in the present embodiment covers the first electrode 501, the piezoelectric layer 502, and the second electrode 503. The metal layer 1300 provided between the first insulation film 1204 and the second insulation film 1205 floats from the first electrode 501, the second electrode 503, the first wiring 504, and the second wiring 505. In other words, the metal layer 1300 is not connected to the first electrode 501, the second electrode 503, the first wiring 504, and the second wiring 505, and the metal layer 1300 is in a floating state with a potential not specified. In this state, the metal layer 1300 plays a role in equalizing the rigidity on the first contact portion side and the rigidity on the second contact portion side.

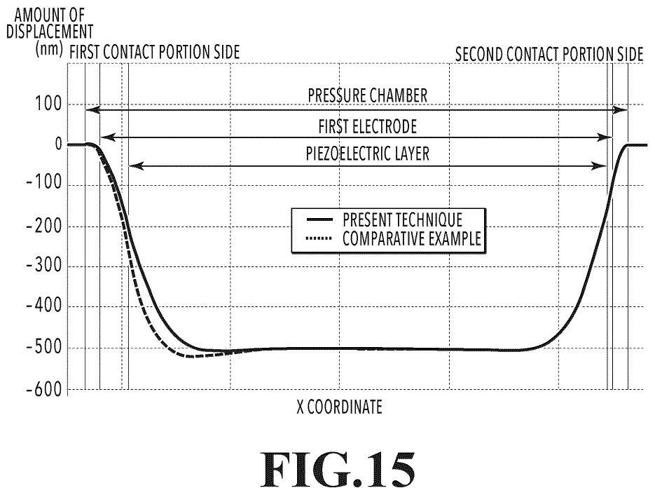

FIG. 15 is a diagram for explaining an effect of the metal layer 1300 thus provided. Specifically, FIG. 15 is a graph chart presenting a simulation result in a case where the diaphragm 403 (see FIG. 12 and others) is deformed with a voltage applied to the piezoelectric layer 502 (see FIG. 12 and others) in the present embodiment. The horizontal axis represents a position in the piezoelectric layer 502 in the X direction and the vertical axis represents an amount of displacement of the diaphragm 403 in the Z direction under application of the voltage to the piezoelectric layer 502. In FIG. 15, the left side in the X coordinate corresponds to the left side in FIGS. 13 and 14, in other words, the side provided with the metal layer 1300. A solid line graph in FIG. 15 represents the amount of displacement of the diaphragm 403 in the piezoelectric element portion 1200 (see FIG. 12 and others) in the present embodiment. Meanwhile, a broken line graph in FIG. 15 represents the amount of displacement of a diaphragm in a piezoelectric element portion in a comparative example not including the metal layer 1300 (see FIG. 14 and others). Here, the piezoelectric element portion 1200 in the present embodiment and the piezoelectric element portion in the comparative example have the same configuration except for the presence/absence of the metal layer 1300.

As presented in FIG. 15, in the diaphragm 403 in the present embodiment, the amount of displacement on the first contact portion 1401 side (see FIG. 14 and others) is approximately equal to the amount of displacement on the second contact portion 1402 side (see FIG. 14 and others). On the other hand, in the diaphragm in the comparative example, the amount of displacement on the first contact portion 1401 side is larger than the amount of displacement on the second contact portion 1402 side.

In addition, the amount of displacement on the first contact portion 1401 side of the diaphragm 403 in the present embodiment is smaller than the amount of displacement on the first contact portion 1401 side of the diaphragm in the comparative example. The amount of displacement on the second contact portion 1402 side of the diaphragm 403 in the present embodiment is approximately equal to the amount of displacement on the second contact portion 1402 side of the diaphragm in the comparative example.

The amount of displacement in the comparative example is asymmetric because the second contact portion 1402 connected on the upper layer side of the piezoelectric layer 502 suppresses the displacement of the piezoelectric layer 502, but the first contact portion 1401 connected on the lower layer side of the piezoelectric layer 502 does not exert such effect. The configuration with the metal layer 1300 provided at the position approximately symmetrical to the second contact portion 1402 as in the present embodiment can also appropriately suppress the displacement of the piezoelectric layer 502 on the first contact portion 1401 side. As a result, the amount of displacement of the diaphragm 403 in the Z direction under application of the voltage to the piezoelectric layer 502 can be made approximately symmetric in the X direction.

In the piezoelectric element portion in the present embodiment, the metal layer is formed on the upper layer above the second electrode 503 at the position approximately symmetrical to the second contact portion 1402 as described above, thereby improving the rigidity on the first contact portion side. As a result, the diaphragm 403 can be deformed in the approximately symmetric form in the X direction under the application of the voltage to the piezoelectric layer 502, so that pealing-off or cracks can be kept from occurring on the first contact portion side.

Therefore, according to the element substrate in the present embodiment, it is possible to enable a stable ejection operation, thereby maintaining the high reliability.

### Modification 1 of Second Embodiment

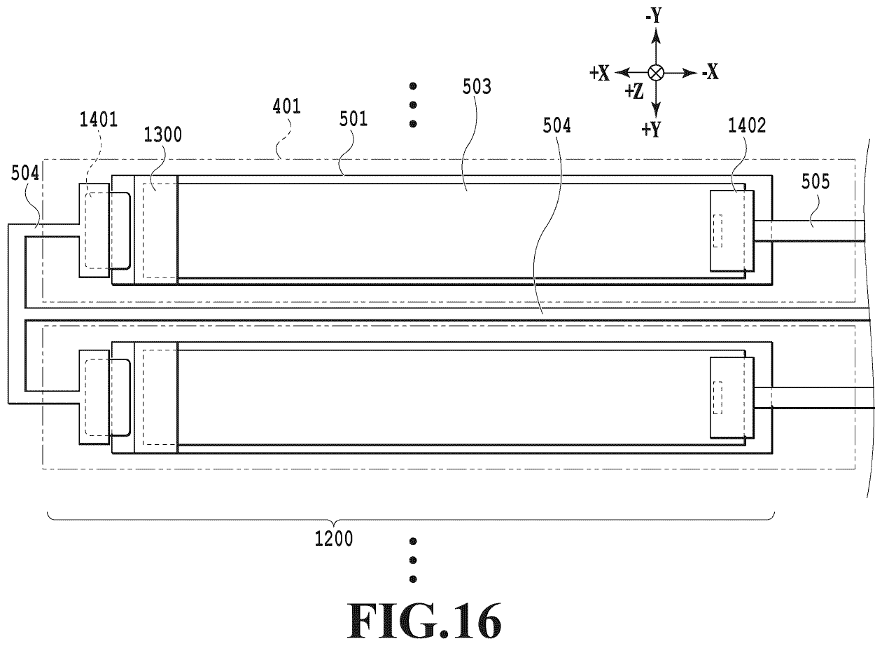

FIG. 16 is a schematic plan view of a piezoelectric element portion 1200 in the present modification.

As illustrated in FIG. 16, a metal layer 1300 may be formed to cover corner portions of a second electrode 503. This configuration has a stronger ability to keep peeling-off from occurring on the first contact portion 1401 side than a configuration in which the corner portions of the second electrode 503 are not covered with the metal layer 1300.

### Modification 2 of Second Embodiment

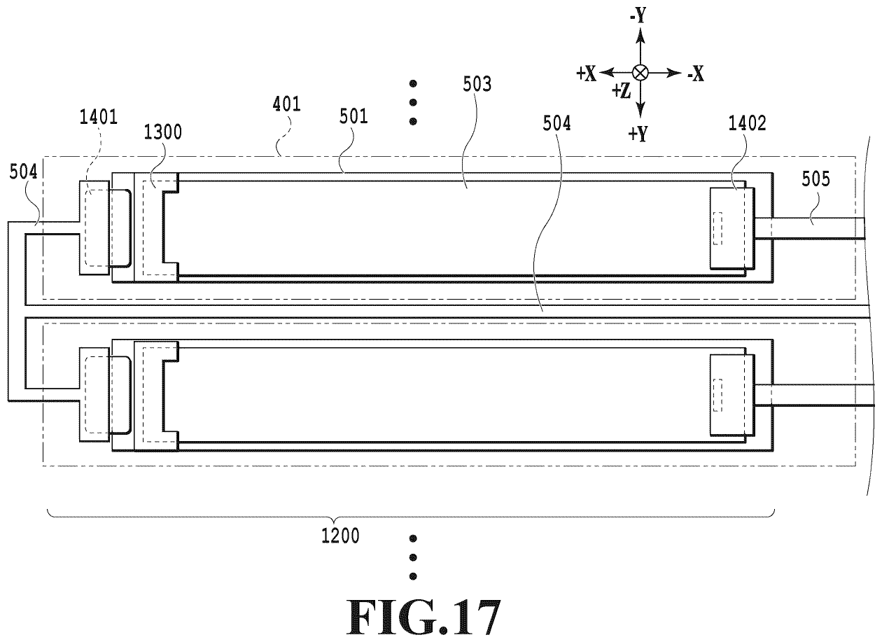

FIG. 17 is a schematic plan view of a piezoelectric element portion 1200 in the present modification.

As illustrated in FIG. 17, in the plan view of the piezoelectric element portion 1200, a metal layer 1300 may be formed in a substantially C-letter shape while covering corner portions of a second electrode 503. This configuration also has a stronger ability to keep peeling-off from occurring on the first contact portion 1401 side than a configuration in which the corner portions of the second electrode 503 are not covered with the metal layer 1300.

### Modification 3 of Second Embodiment

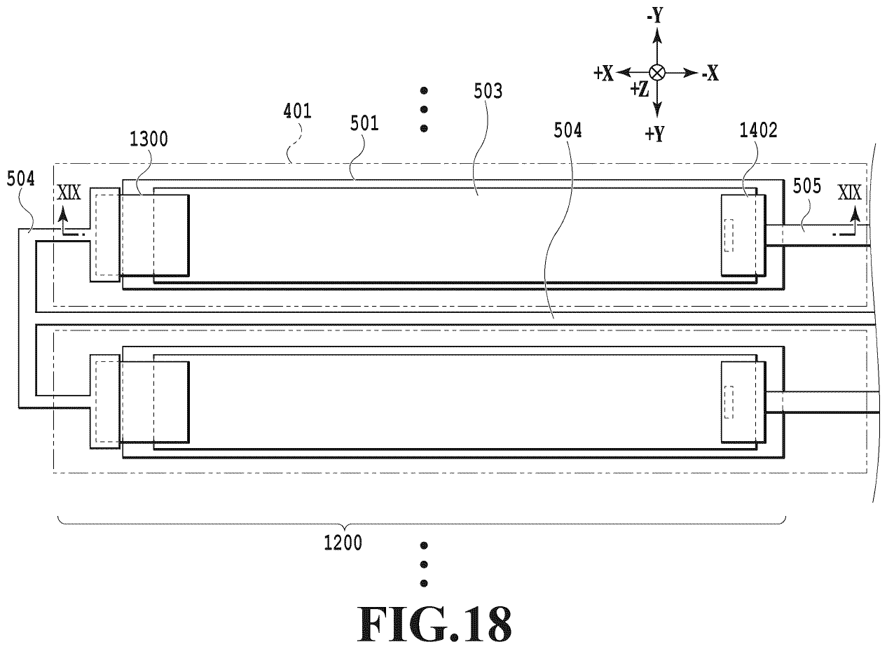

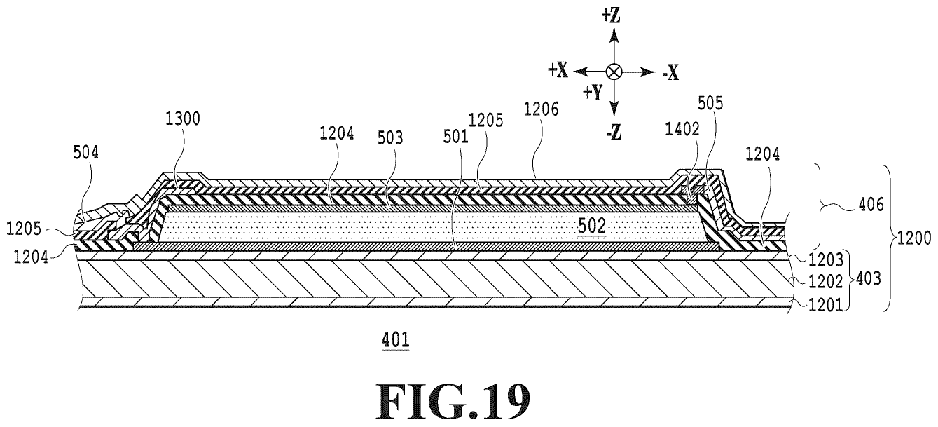

FIG. 18 is a schematic plan view of a piezoelectric element portion 1200 in the present modification, and FIG. 19 is a cross-sectional view taken along a line XIX-XIX in FIG. 18.

As illustrated in FIG. 19, in the piezoelectric element portion 1200 in the present modification, a metal layer 1300 also functions as a first contact portion 1401.

As illustrated in FIG. 19, the metal layer 1300 in the present modification is formed in the same layer as a contact (first contact portion 1401) for a first electrode. The metal layer 1300 extends outward along a first insulation film 1204 and is connected to a first electrode 501. In sum, the metal layer 1300 in the present modification plays a role in suppressing the displacement of the piezoelectric layer 502 and a role in electrically connecting the first electrode 501 and a first wiring 504. This configuration also has an ability to appropriately suppress the displacement of the piezoelectric layer 502 and keep peeling-off from occurring on the first contact portion 1401 side.

### Modification 4 of Second Embodiment

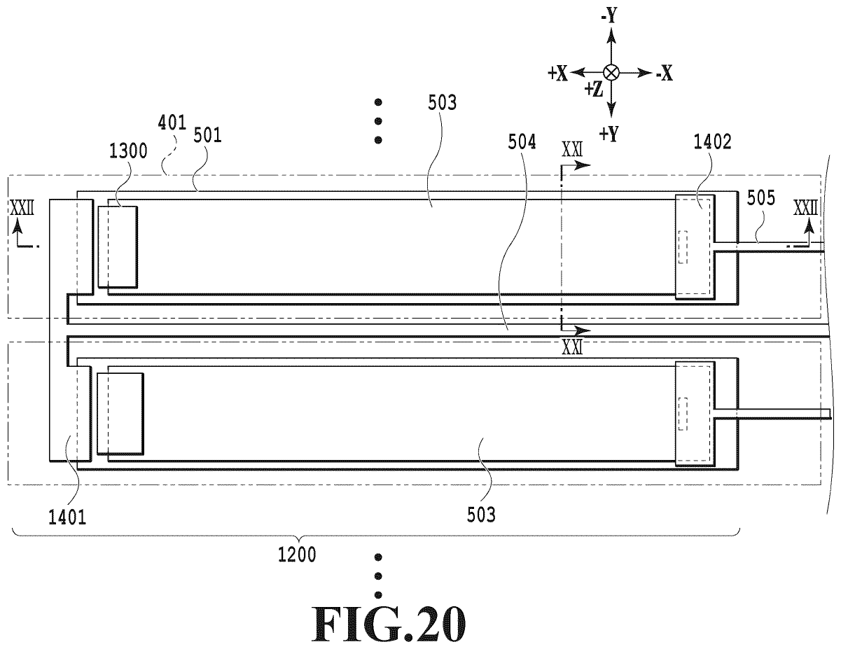

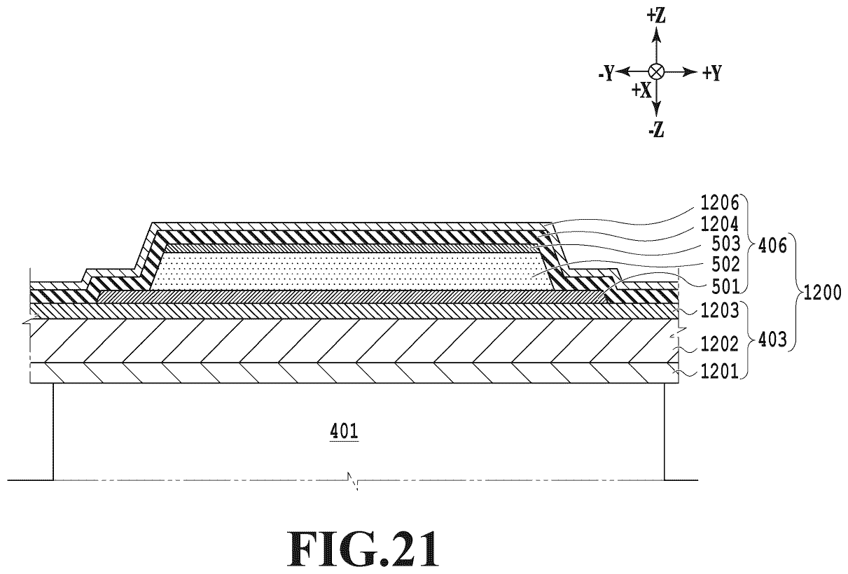

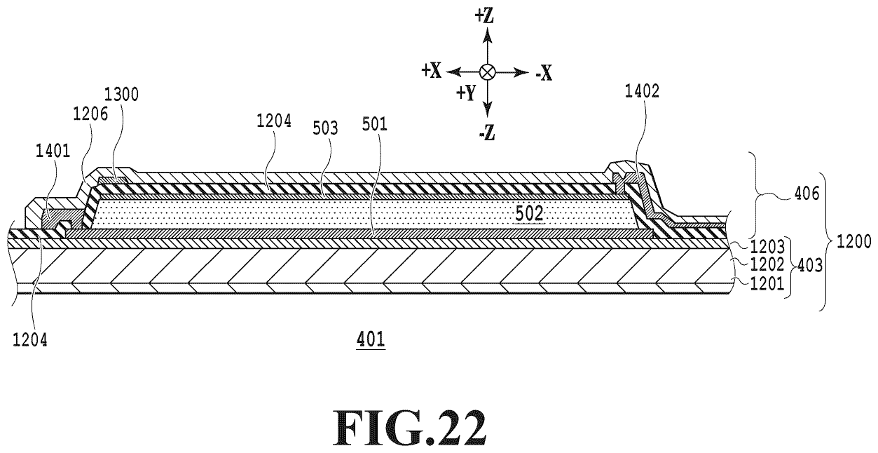

FIG. 20 is a schematic plan view of a piezoelectric element portion 1200 in the present modification, FIG. 21 is a cross-sectional view taken along a line XXI-XXI in FIG. 20, and FIG. 22 is a cross-sectional view taken along a line XXII-XXII in FIG. 20.

As illustrated in FIGS. 21 and 22, the piezoelectric element portion 1200 in the present modification does not include a second insulation film 1205 (see FIG. 12 and others), and a sealing layer 1206 is formed immediately on a first insulation film 1204.

As illustrated in FIG. 22, in the piezoelectric element portion 1200 in the present modification, a first contact portion 1401 and a second contact portion 1402 are formed in the same layer. Accordingly, in the piezoelectric element portion 1200 in the present modification, there is no need to form the second insulation film 1205 (see FIG. 12 and others) to insulate the second contact portion 1402, which may be otherwise formed in a layer above the first contact portion 1401. Only with the formation of the first insulation film 1204, it is possible to isolate both of the first contact portion 1401 and the second contact portion 1402.

Therefore, this configuration can eliminate work for forming the second insulation film 1205.

### OTHER EMBODIMENTS

In the first embodiment, the first wiring 504, the deformation suppression portion 510, and the second wiring 505 are made of gold. However, the material applicable to the first wiring 504, the deformation suppression portion 510, and the second wiring 505 is not limited to gold. For example, the first wiring 504, the deformation suppression portion 510, and the second wiring 505 may be made of aluminum. In the case where aluminum is used to form the first wiring 504, the deformation suppression portion 510, and the second wiring 505, their film thickness is preferably about 500 nm or more. This configuration also makes it possible to obtain the same effect as in the first embodiment.

In addition, the element substrate 200 may be supplied with the liquid from a tank detachably attached to the liquid ejection head 101 or may be supplied with the liquid via a tube from a tank provided outside the liquid ejection head 101.

Moreover, the liquid ejection apparatus 100 may include a pump and a channel to circulate the liquid not ejected from the element substrate 200 between the element substrate 200 and a tank that stores the liquid.

The constituent elements described in the foregoing embodiments are just examples. Thus, the technical scope of the present disclosure should not be limited to the foregoing examples. The present disclosure describes the examples using the liquid ejection method. However, the technique of the present disclosure is not limited to these examples but may be modified or altered in various ways within the scope of the gist.

According to the technique disclosed herein, it is possible to provide an element substrate capable of applying an equal voltage to piezoelectric elements while maintaining high reliability.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-130777, filed Aug. 7, 2024, and No. 2025-093543, filed Jun. 4, 2025, which are hereby incorporated by reference herein in their entirety.

What is claimed is:

1. An element substrate comprising:
a pressure chamber configured to store a liquid;
a diaphragm configured as a wall surface of the pressure chamber; and
a piezoelectric device configured to vibrate the diaphragm, wherein the piezoelectric device includes:
a first electrode,
a piezoelectric layer laminated on the first electrode in a predetermined direction,
a second electrode stacked on the piezoelectric layer in the predetermined direction,
an insulation layer laminated on the second electrode in the predetermined direction,
a first wiring electrically connected to the first electrode,
a second wiring electrically connected to the second electrode, and
a deformation suppression portion configured to partially hold down the piezoelectric layer from the predetermined direction,
in a case where longitudinal directions of the piezoelectric layer are defined as directions along an X axis crossing the predetermined direction, one of the directions along the X axis is denoted by a −X direction, and the other direction along the X axis, which is opposite to the −X direction, is denoted by a +X direction,
the piezoelectric device has
a first region in which the first electrode, the insulation layer, and the first wiring are laminated in the predetermined direction in this order,
a second region that is located at the +X direction side of the first region, and in the second region, the first electrode, the piezoelectric layer, the insulation layer, and the deformation suppression portion are laminated in the predetermined direction in this order, and
a third region that is located at the +X direction side of the second region, and in the third region, the first electrode, the piezoelectric layer, the insulation layer, and the second wiring are laminated in the predetermined direction in this order, and
the deformation suppression portion is electrically isolated from the piezoelectric layer.

2. The element substrate according to claim 1, wherein the deformation suppression portion is formed of the same material as the first wiring or the second wiring and has the same thickness as the first wiring or the second wiring.

3. The element substrate according to claim 1, wherein the deformation suppression portion is not electrically connected to the first wiring and the second wiring.

4. The element substrate according to claim 1, wherein the deformation suppression portion is provided along an inclined surface shape of the piezoelectric layer having a certain height in the predetermined direction so as to cover the piezoelectric layer.

5. The element substrate according to claim 1, wherein, in a view from a direction along a Y axis crossing the predetermined direction and the X axis, the deformation suppression portion and the second wiring are provided at positions symmetric with respect to the piezoelectric layer.

6. The element substrate according to claim 1, wherein
the deformation suppression portion includes:
a first flat portion where the insulation layer and the deformation suppression portion are laminated while extending in the direction along the X axis,
an inclined portion that is adjacent to the first flat portion in the +X direction, and in the inclined portion, the insulation layer and the deformation suppression portion are laminated while extending along an inclined portion of the piezoelectric layer, and
a second flat portion that is adjacent to the inclined portion in the +X direction, and in the second flat portion, the insulation layer and the deformation suppression portion are laminated while extending in the direction along the X axis.

7. The element substrate according to claim 1, wherein a plurality of the piezoelectric devices are arrayed in a direction along a Y axis, the Y axis crossing the predetermined direction and the direction along the X axis.

8. A liquid ejection head comprising the element substrate according to claim 1, wherein
with application of a voltage between the first electrode and the second electrode, the diaphragm is vibrated, thereby causing a liquid to be ejected from an ejection port opposed to the piezoelectric device.

9. An element substrate comprising:
a pressure chamber configured to store a liquid;
a diaphragm configured as a wall surface of the pressure chamber; and
a piezoelectric device configured to vibrate the diaphragm, wherein the piezoelectric device includes:
a first electrode,
a piezoelectric layer laminated on the first electrode in a predetermined direction,
a second electrode stacked on the piezoelectric layer in the predetermined direction,
a first insulation layer laminated on the second electrode in the predetermined direction,
a metal layer laminated on the first insulation layer in the predetermined direction,
a first wiring configured to supply electric power to the first electrode, and
a second wiring configured to supply electric power to the second electrode,
the first electrode and the first wiring are electrically connected to each other via a first contact portion at an end portion in the longitudinal direction of the piezoelectric layer,
the second electrode and the second wiring are electrically connected to each other via a second contact portion at an other end portion in the longitudinal direction of the piezoelectric layer opposite to the one longitudinal end,
the first contact portion and the second contact portion are arranged in a region overlapping the pressure chamber in a view seen along the predetermined direction, and
the metal layer is arranged at a position that is different from a position of the first contact portion in the predetermined direction but is a position of the second contact portion in the predetermined direction.

10. The element substrate according to claim 9, wherein the metal layer is formed in the same layer as the first contact portion and the second contact portion, and the metal layer is made of the same material as the first contact portion and the second contact portion.

11. The element substrate according to claim 9, wherein the metal layer and the first contact portion are connected to each other.

12. The element substrate according to claim 9, wherein the metal layer is not connected to the first electrode, the second electrode, the first wiring, and the second wiring, and the metal layer is in a floating state with a potential not specified.

13. The element substrate according to claim 9, wherein the metal layer covers a corner portion of the second electrode.

14. The element substrate according to claim 9, wherein, in the longitudinal direction, the metal layer protrudes outward from an end of the second electrode by 5 μm or more.

15. The element substrate according to claim 9, wherein the element substrate satisfies the following formula:
Lx_in2×0.8≤Lx_in ≤Lx_in2×1.2,
where Lx_in denotes a length of the metal layer extending inward from an end of the second electrode in the longitudinal direction, and Lx_in2 denotes a length of the second contact portion extending inward from the other end of the second electrode in the longitudinal direction.

16. The element substrate according to claim 9, wherein
the element substrate satisfies the following formula:
Wp×0.7≤Wc2≤Wp,
where Wc2 denotes a length of the second contact portion in a width direction crossing the longitudinal direction in a plane and Wp denotes a length of the piezoelectric layer in the width direction.

17. The element substrate according to claim 9, wherein
the element substrate satisfies the following formula:
We×0.7≤Wc1≤We,
where Wc1 denotes a length of the first contact portion in a width direction crossing the longitudinal direction in a plane and We denotes a length of the first electrode in the width direction.

18. The element substrate according to claim 9, wherein
the element substrate satisfies the following formula:
Wc2×0.8≤Wm≤Wch,
where Wm denotes a length of the metal layer in a width direction crossing the longitudinal direction in a plane, Wc2 denotes a length of the second contact portion in the width direction, and Wch denotes a length of the pressure chamber in the width direction.

19. The element substrate according to claim 9, wherein a young's modulus of the metal layer is 10% or more and 80% or less of a Young's modulus of the piezoelectric layer.

20. The element substrate according to claim 9, wherein a residual stress of the metal layer is within a range of −100 MPa to +100 MPa.

21. The element substrate according to claim 9, wherein a material for the metal layer is an inorganic material containing Al and is the same as a material for the first contact portion or a material for the second contact portion.

22. The element substrate according to claim 9, wherein the first contact portion and the second contact portion are provided within a range of a length of the pressure chamber in the longitudinal direction.

23. The element substrate according to claim 9, wherein
a length of the first electrode in the longitudinal direction is shorter than a length of the pressure chamber in the longitudinal direction, and
a length of the first electrode in a width direction crossing the longitudinal direction in a plane is shorter than a length of the pressure chamber in the width direction.

24. The element substrate according to claim 9, further comprising:
a second insulation layer laminated on the metal layer in the predetermined direction; and
a sealing layer laminated on the second insulation layer in the predetermined direction.

25. The element substrate according to claim 9, further comprising a sealing layer laminated on the first insulation layer and the metal layer in the predetermined direction.

26. A liquid ejection head comprising:
an element substrate,
the element substrate having a pressure chamber containing liquid, a diaphragm configured as a wall surface of the pressure chamber, and a piezoelectric device vibrating the diaphragm, wherein
the piezoelectric device includes:
a first electrode,
a piezoelectric layer laminated on the first electrode in a predetermined direction,
a second electrode stacked on the piezoelectric layer in the predetermined direction,
a first insulation layer laminated on the second electrode in the predetermined direction,
a metal layer laminated on the first insulation layer in the predetermined direction,
a first wiring configured to supply electric power to the first electrode, and
a second wiring configured to supply electric power to the second electrode,
the first electrode and the first wiring are electrically connected to each other via a first contact portion at an end portion in the longitudinal direction of the piezoelectric layer,
the second electrode and the second wiring are electrically connected to each other via a second contact portion at an other end portion in the longitudinal direction of the piezoelectric layer opposite to the one longitudinal end,
the first contact portion and the second contact portion are arranged in a region overlapping the pressure chamber in a view seen along the predetermined direction, and
the metal layer is arranged at a position that is different from a position of the first contact portion in the predetermined direction but is a position of the second contact portion in the predetermined direction,
wherein with application of a voltage between the first electrode and the second electrode, the diaphragm is vibrated, thereby causing a liquid to be ejected from an ejection port opposed to the piezoelectric device.
